(19) United States
(12) Patent Application Publication
(10) Pub. No.: US 2026/0189768 A1
(43) Pub. Date: Jul. 2, 2026

(54) ARTIFICIAL INTELLIGENCE-BASED GRAPHIC STORY BOOKS CONVERSION

(71) Applicant: Trilogy1 LLC, Las Vegas, NV (US)

(72) Inventors: Shane Bersiek, Las Vegas, NV (US); Thomas Chen, Costa Mesa, CA (US)

(21) Appl. No.: 19/371,942

(22) Filed: Oct. 28, 2025

Related U.S. Application Data
(60) Provisional application No. 63/739,272, filed on Dec. 27, 2024.

(51) Int. Cl. H04N 21/81; G06V 10/77; G06V 40/16; H04N 21/44

(52) U.S. Cl. CPC H04N 21/816; G06V 10/7715; G06V 40/168; G06V 40/172; H04N 21/44016

(57) ABSTRACT

A system and method for converting graphic story books into multi-dimensional content using artificial intelligence is disclosed. Features are extracted from a graphic story book that includes a sequence of image panels. The features include image features representing objects within each panel and text features representing textual content. An AI model is used to enrich the content based on the extracted features by generating audio content that includes verbal descriptions of scenes and utterances from characters. Visual attributes of characters are analyzed to determine appropriate voice profiles for each character, and speeches are generated for the characters based on their respective voice profiles. Video clips are created by combining image panels that represent sequences of related movements. The enriched content includes a time dimension where different portions are presented according to a timeline.

### CROSS REFERENCE TO RELATED APPLICATION

The present application claims priority to U.S. Provisional Patent Application Ser. No. 63/739,272, filed Dec. 27, 2024, which is incorporated herein by reference in its entirety.

### TECHNICAL FIELD

The present specification generally relates to providing an artificial intelligence-based framework for converting graphic novel to multi-dimensional content.

### BACKGROUND

Audiobooks have become popular because they enable people to consume written content at settings where reading can be difficult (e.g., while driving, while exercising, etc.). Such a concept of converting content from one dimension to another dimension (e.g., from written materials into audio content, etc.) has not expanded to graphic story books. Graphic story books are single-dimensional visual content that tell stories using a sequence of image panels (e.g., images, drawings, pictures, etc.). Graphic story books may be fictional or non-fictional, and may include graphic novels, manga, or comic books. Unlike non-graphic books which include mostly words that can be easily converted into spoken words (by humans or machines), it is challenging to convert a graphic story book from the single dimensional content (e.g., visual content) into content in another dimension (e.g., audio content, etc.) or multi-dimensional content (e.g., a combination of audio and visual content, etc.). Furthermore, even if the visual content is converted into audio content, the verbal narration (even if it can be created) remains a single-dimensional content (i.e., in an audio dimension instead of a visual dimension), and may remove some of the allures provided by the graphic story books to the readers. As such, there is a need to provide an automated computer system that can efficiently convert a graphic story book into content with multiple dimensions such that the graphic story books can be presented via different media.

### BRIEF DESCRIPTION OF THE FIGURES

FIG. 1 is a block diagram illustrating an electronic transaction system according to an embodiment of the present disclosure;

FIG. 2 illustrates an example sequence of panels from a graphic story book according to an embodiment of the present disclosure;

FIG. 3A is a block diagram illustrating a conversion module according to an embodiment of the present disclosure;

FIG. 3B is a flow chart illustrating a process of converting a graphic story book to a multi-dimensional content according to an embodiment of the present disclosure;

FIG. 4 illustrates an example neural network that can be used to implement a machine learning model according to an embodiment of the present disclosure; and

FIG. 5 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing an artificial intelligence (AI)-based computer framework for converting graphic story books to multi-dimensional content, such that the graphic story books can be consumed in an enriched experience. A graphic story book is a visual content that tells a story using a sequence of image panels (e.g., graphics, images, pictures, etc.). Each image panel may include a static frame associated with the story, which may include a visual illustration of a background scene, a brief narration (e.g., specifying a time of day, a location, etc.), a visual illustration of one or more characters, words spoken by the one or more characters (e.g., the words are typically encompassed within a “chat bubble”), a visual illustration of one or more actions performed by the one or more characters in a static format. An image panel may also be connected to one or more other image panels in the sequence (e.g., connected to the image panel that comes before, connected to the image panel that comes after, etc.), such that a reader may understand the story by viewing the image panel in sequence (e.g., in an order).

As such, a graphic story book is a one-dimensional content, that is, unlike an animated movie that typically provides at least visual and audio content, a graphic story book provides only visual content to the reader. There are circumstances where people are not able to enjoy a graphic story book (e.g., when the person is operating a machine, when the person is exercising, etc.). By converting the graphic story book to another dimension of content and/or adding another dimension of content to the graphic story book, the conversion system may enable people to enjoy graphic story books in more settings or with an enriched experience.

The AI-based computer framework includes a conversion system that configures and trains an AI model (e.g., a large language model, a small language model, etc.) for converting graphic story books into multi-dimensional contents (e.g., also referred to as “enriched contents”). The conversion system may obtain graphic story book content from a user via a user interface. For example, users (e.g., a creator of a graphic story book, etc.) may upload content associated with a graphic story book to the conversion system. The content uploaded to the conversion system may include a sequence of image panels. The conversion system may provide the content (and/or features extracted from the content) to the AI model, and instruct the AI model to generate enriched content for the graphic story book based on the content and the features extracted from the content.

For example, the system may instruct the AI model to analyze the sequence of image panels to understand different attributes of the graphic story book, including the plot of the story illustrated in the graphic story book, the characters of the story, the language used in the story. The conversion system may then instruct the AI model to generate enriched content based on the sequence of image panels. For example, the conversion system may instruct the AI model to generate a verbal narration for one or more image panels in the sequence of image panels based on the analysis. The verbal narration for each image panel may provide description of the scene depicted in the image panel, any action(s) performed by one or more characters that appear in the image panel, and words “spoken” by one or more characters that appear in the image panel. In some embodiments, the verbal narration may provide sufficient details of the image panel such that a reader may understand the depiction of the image panel without viewing the image panel.

In some embodiments, the system may instruct the AI model to use different voices having different vocal characteristics to render the audio words spoken by different characters in the story. For example, the AI model may analyze the visual characteristics of each character that appears in the graphic story book (e.g., a gender, a body shape, facial features, hair features, etc.), and determine a voice having a particular set of voice characteristics (e.g., a pitch, a tone, a coarseness, an accent, a volume, etc.) for each corresponding character. The AI model may assign a corresponding voice to each character, and render the words spoken by each character using the voice assigned to the character.

In order to determine the voice characteristics for each character in the story, the conversion system of some embodiments first obtain a large voice data pool that is associated with a variety of people (e.g., voices from actors/actresses obtained from various movies and television shows, etc.). The conversion system may then cluster the voice data pool by assigning voice data associated with each person to a cluster based on the physical attributes (e.g., a gender, facial features, a body shape, hair features, etc.) of the person, such that voice data associated with people having similar physical attributes (e.g., similar height, similar facial features, similar body shape, etc.) would be grouped within the same cluster. In some embodiments, the conversion system may train the AI model using the voice data pool, such that the AI model may be trained to accurately predict a person's voice based on the physical characteristics of the person.

When analyzing a character in the story, the conversion system may first extract physical attributes of the person (based on analyzing image panels that show the same character in the graphic story book). Since it may be challenging to obtain accurate measurements of different attributes (e.g., heights, weights, sizes, etc.) in the image panels, the conversion system may use other objects (e.g., common objects such as a house, a car, a street sign, etc.) within the image panel aside from the character to provide a measurement guidance. The conversion system may then provide the physical attributes of the character to the AI model, such that the AI model may generate a voice profile representing voice characteristics for the character. In some embodiments, the AI model may assign the character to a particular cluster based on the physical attributes, and may generate the voice profile using the voice data within the cluster (e.g., an average voice within the cluster, etc.).

After generating the audio component for an image panel (which may include a narration of the scene and actions of the characters, and voices produced by each character), the conversion system may link the audio component with the image panel within the enriched content, such that the audio component will be presented as the image pane is displayed when the enriched content is played on a user device. For example, the conversion system may generate a motion graphic story book for the graphic story book. A motion graphic story book is not an animation/a movie. Instead, a motion graphic story book enriches the content of the graphic story book by adding a time dimension to the content. For example, the AI model may generate the motion graphic story book by sequentially displaying each image panel at a time in the order of the sequence. In some embodiments, the conversion system may track a reader's interaction with one or more other digitized version of graphic story books, and determine a speed of displaying the different image panels for the reader, such that the different pieces of visual art are displayed on a user device according to the speed. As the audio data for each image panel is linked to the image panel in the enriched content, the conversion system may enable an application to play the corresponding audio data when the corresponding image a panel is displayed on the user device.

In some embodiments, instead of playing all of the image panels one by one along a specific timeline, the conversion system may also enrich some of the image panel by converting some of the image panels into video clips. For example, the conversion system may instruct the AI model to generate one or more video clips based on one or more image panels in the graphic story book. The conversion system may instruct the AI model to identify any image panel or a subset of the image panels that depict a motion or movement (e.g., two characters walking toward each other, a car moving, etc.), and then generate a video clip to illustrate the motion. In some embodiments, the conversion system may also instruct the AI model to use the image panel(s) as video frames and put the video frames together to form a video clip. In some embodiments, the conversion system may also instruct the AI model to generate one or more additional video frames based on the image panel(s). For example, the AI model may generate additional video frames such that the motion may appear smoother in the video clip. The additional video frames may be inserted in between the existing video frames generated from the image panel(s). The conversion system may also insert the audio data that is linked to the image panel(s) used to generate the video clip into the video clip. In some embodiments, the conversion system may replace the image pane(s) used to generate the video clip with the video clip in the enriched content, such that a smooth depiction of the motion/movement is presented when the enriched content is rendered on a user device.

In some embodiments, the AI model is also instructed to break down each image panel into different components (e.g., a background scene component, a character component, a chat bubble component, etc.). The AI model may then generate additional image panel(s), based on the different components. For example, the AI model may generate a first image panel that includes the background scene component of the original image panel, a second image panel that includes both the background scene component and the character component of the original image panel, and a third image panel that includes all of the components in the original image panel. The conversion system may then link different portions of the audio data associated with the original image panel to each of the newly generated image panels. For example, the conversion system may link a narration associated with the background component with the first image panel, link a narration associated with a description of the characters to the second image panel, and link the voices of the characters to the third image panel. The conversion system may also replace the original image panel in the enriched data with the newly generated multiple image panels to further enhance the content of the graphic story book.

Based on the information included in the enriched content, the application (or the system) may render each image panel on the user device to synchronize with the audio narration generated by the AI model based on the links. For example, the application and/or the conversion system may initially render the first image panel depicting only the background scene as the narration describing the background of the scene is presented based on the information included in the enriched content. The application and/or the conversion system may then render a character on the user device when the narration describing the character and/or an action performs by the character is presented based on the information included in the enriched content. The application and/or the conversion system may also render the chat bubble of the character as the voice representing the words spoken by the corresponding character is presented based on the information in the enriched content.

By adding the time dimension and the audio dimension to the visual dimension of the graphic story book, the conversion system enhances the experience of the reader while consuming the content of the graphic story book and/or enabling the reader to consume the content of the graphic story book when the ability to read the visual content is limited.

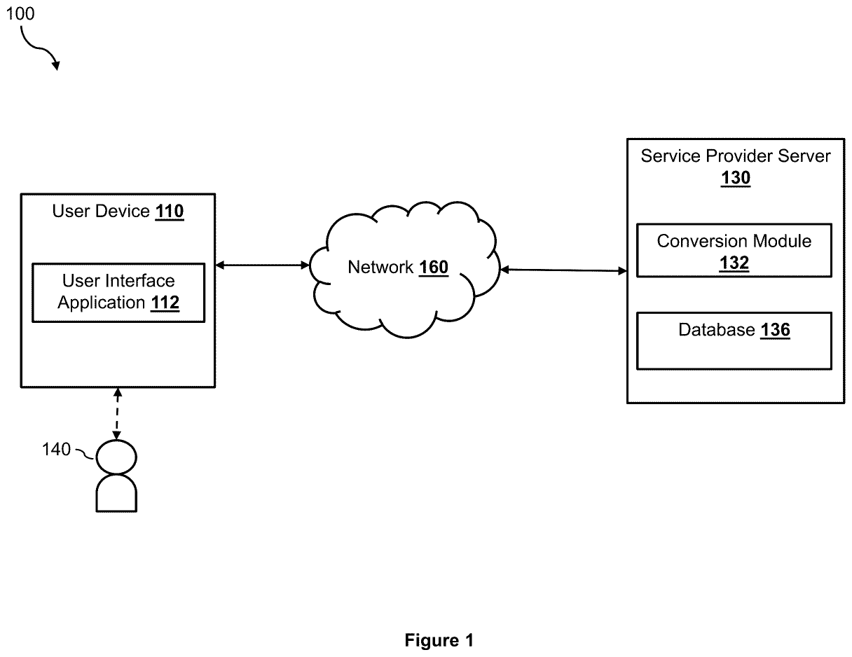

FIG. 1 illustrates an electronic networked system 100, within which the conversion system may be implemented according to one embodiment of the disclosure. The electronic networked system 100 includes a service provider server 130 and a user device 110 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the service provider server 130 over the network 160. For example, the user 140 may use the user device 110 to upload visual content associated with a graphic story book to the service provider server 130. The user 140 may also use the user device 110 to view, download, and/or access enriched content generated by the service provider server 130 based on the visual content associated with the graphic story book. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile application that is downloaded from an app store, etc.), which may be utilized by the user 140 to interact with the service provider server 130 over the network 160. In one implementation, the user interface application 112 includes a software program (e.g., a mobile application) that provides a graphic user interface (GUI) for the user 140 to interface and communicate with the service provider server 130 via the network 160. In another implementation, the user interface application 112 includes a browser module that provides a network interface to browse information available over the network 160. For example, the user interface application 112 may be implemented, in part, as a web browser to view information available over the network 160.

While only one user device 110 is shown in FIG. 1, it has been contemplated that multiple user devices, each associated with a different user, may be connected to the merchant server 120 and the service provider server 130 via the network 160.

The service provider server 130, in one embodiment, may provide functionalities of the conversion system as disclosed herein. As such, the service provider server 130 may include a conversion module 132 configured to convert the visual content associated with a graphic story book provided by a user, and provide the converted content to various users. For example, the conversion module 132 may include and use an artificial intelligence (AI) model to generate enriched content based on the visual content associated with the graphic story book. The enriched content may include audio content such as audio content (e.g., the narration, words spoken by one or more characters in the graphic story book, etc.), character information associated with each character appearing in the graphic story book (e.g., voice characteristics, etc.), timeline content such as a time interval presenting each image panel in the graphic story book, broken-down components for each image panel and an order for presenting each of the components, video clips generated based on one or more of the image panels, and other information. The enriched content can be stored as a package within the database 136. When a user requests access to the enriched content, the conversion module 132 may communicate with the user interface application 112, and render the enriched content via a user interface of the user interface application on the user device 110.

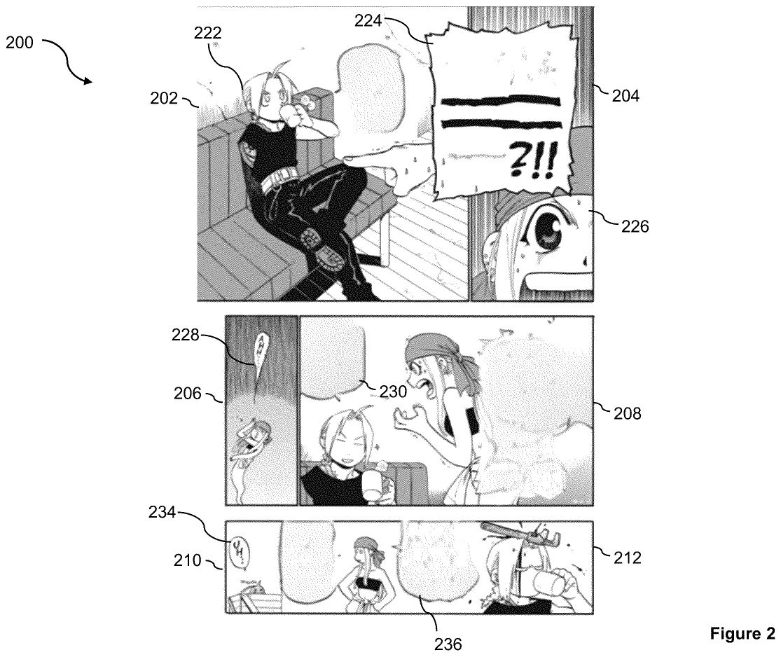

FIG. 2 illustrates an example sequence of image panels 200 associated with a graphic story book. As shown, the sequence of image panels 200 includes multiple individual image panels (e.g., image panels 202, 204, 206, 208, 210, and 212) in a particular order. Each of the image panels 202, 204, 206, 208, 210, and 212 depicts various aspects of a scene. For example, the image panel 202 depicts a person 222 sitting on a couch enjoying a drink while another person (face not shown) pointing a finger at the person 222. The next image panel 204 depicts the other person 226 yelling out words included in a chat bubble 224. The chat bubble is a typical way of showing words and/or sounds made by characters in a graphic story book.

In the next image panel 206, the person 226 is making the sound “AHH,” before the person 226 screams at the person 222 again in the image panel 208. The image panel 206 also shows that the person 222 speaks to the person 226 via a chat bubble 230. In the next image panel 210, an animal sitting on a roof of a building makes a sound via a chat bubble 234. In the final image panel 212, it appears that an object has been used to hit the head of the person 222, causing the person 222 to bleed while still drinking a drink from a cup. The image panel 212 also shows that the person 226 speaks to the person 222 via a chat bubble 236.

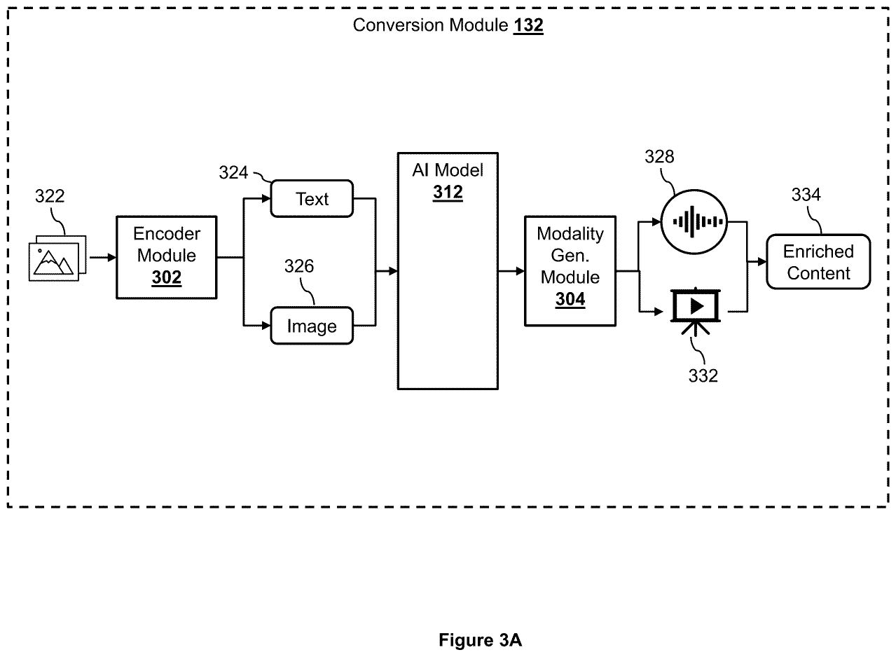

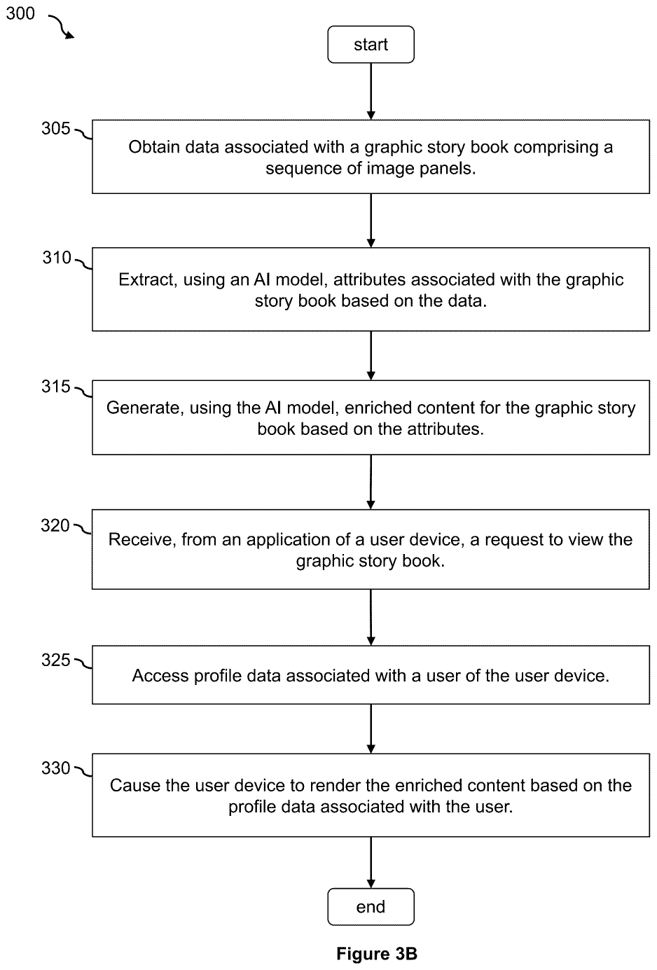

FIG. 3A illustrates a detailed block diagram of the conversion module 132 that may be used to implement the AI-based framework for converting graphic story books to multi-dimensional content according to various embodiments of the disclosure. The conversion module 132 includes several interconnected components that work together to process and transform visual content from graphic story books into enriched, multi-dimensional content. The conversion module 132 receives a sequence of image panels 322 as input, which represents the visual content of a graphic story book similar to the sequence of image panels 200 shown in FIG. 2. For example, the user 140 of the user device 110 may use the user interface application 112 to upload the sequence of image panels 322 to the conversion module 132. The sequence of image panels 322 may include multiple individual image panels that depict various scenes, characters, backgrounds, and text elements such as chat bubbles containing dialogue or sound effects.

The encoder module 302 serves as the first processing component within the conversion module 132. The encoder module 302 receives the sequence of image panels 322 and performs feature extraction operations to analyze and understand the content within each image panel. The encoder module 302 processes the visual information to generate two distinct types of features: text features 324 and image features 326. The text features 324 may represent textual content extracted from the image panels, such as words within chat bubbles, narrative text, sound effects, or other written elements present in the graphic story book. The image features 326 may represent visual characteristics of the image panels, including background scenes, character appearances, facial features, body features, objects, colors, compositions, and spatial relationships between different elements within each panel.

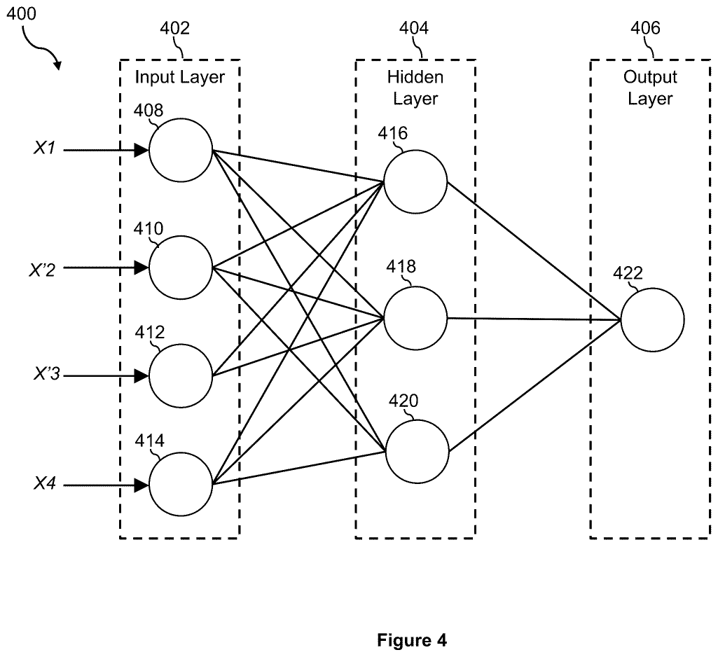

The AI model 312 receives both the text features 324 and the image features 326 from the encoder module 302 as inputs. The AI model 312 may be implemented using machine learning techniques such as the artificial neural network 400 described in FIG. 4, and may include large language models, small language models, a recurrent convolutional neural network, or other AI architectures trained specifically for content conversion tasks. Specifically, the AI model 312 may be configured to receive and analyze features associated with the sequence of image panels 322 in an order (an order associated with the graphic story book associated with the sequence of image panels 322), such that the AI model can understand the story, the plot and other features of the story associated with the graphic story book. The AI model 312 analyzes the received features to understand the narrative structure, character relationships, dialogue patterns, scene descriptions, and temporal sequences within the graphic story book. Based on this analysis, the AI model 312 generates processed information that captures the semantic meaning, character attributes, plot elements, and other contextual information necessary for creating multi-dimensional content.

In some embodiments, the AI model 312 generates various types of processed data usable to create multi-dimensional content from the graphic story book. For example, the AI model 312 may generate narrative descriptions for each image panel in the sequence, providing detailed verbal descriptions of the visual scenes, character actions, environmental settings, and contextual information that may not be explicitly stated in the original graphic content. These narrative descriptions may serve as audio narration that can be synchronized with the display of each corresponding image panel, allowing users to understand the story content through auditory means.

The AI model 312 may also analyze the visual characteristics of characters appearing throughout the graphic story book to determine distinct voice profiles for each character. In some cases, the AI model 312 may examine facial features, body structure, age indicators, gender characteristics, and other physical attributes of each character to generate corresponding voice profiles that include parameters such as pitch, tone, accent, speaking pace, and vocal timbre. The voice profiles may be designed to match the perceived personality and physical characteristics of each character as depicted in the visual content. In some embodiments, the AI model 312 uses the clustering technique disclosed herein to generate the voice profiles for the characters appearing in the sequence of image panels 322.

Based on the determined voice profiles, the AI model 312 may generate audio data representing the spoken words and vocalizations of each character. In some aspects, the AI model 312 may convert text content extracted from chat bubbles and dialogue elements into synthesized speech using the appropriate voice profile for each character. The generated audio data may include not only spoken dialogue but also character-specific sound effects, emotional expressions, and vocal reactions that correspond to the actions and situations depicted in the image panels.

In some embodiments, the AI model 312 may also generate short video clips by combining and processing multiple image panels from the graphic story book. The AI model 312 may identify sequences of image panels that depict motion, action, or temporal progression, and may stitch these panels together to create animated video segments. In some cases, the AI model 312 may generate additional intermediate image panels to create smoother transitions between existing panels, enhancing the visual flow and creating more fluid motion in the resulting video clips. These generated video clips may incorporate the corresponding audio data, including character voices and narrative descriptions, to provide a synchronized audio-visual experience that enriches the original static graphic content.

The modality generation module 304 receives the processed information from the AI model 312 and transforms this information into different content modalities. The modality generation module 304 generates multiple output components, including an audio component 328 and a video component 332. The audio component 328 may include verbal narrations describing scenes and actions, character voices with distinct vocal characteristics based on visual attributes of the characters, sound effects, and other audio elements that correspond to the content of the image panels. The video component 332 may include video clips generated from sequences of related image panels that depict motion or movement, additional video frames created to smooth transitions between static images, and temporal sequencing information for presenting the content over time.

The conversion module 132 combines the audio component 328 and video component 332 generated by the modality generation module 304 with the original sequence of image panels 322 to produce enriched content 334. The enriched content 334 represents the final multi-dimensional output that includes the original visual dimension enhanced with audio and temporal dimensions. The enriched content 334 may include synchronized audio-visual presentations where specific audio elements are linked to corresponding image panels, video clips that replace static image sequences to show smooth motion, and timeline information that controls the presentation sequence and timing of different content elements (e.g., the different image panels, short video clips, etc.) when rendered on a user device.

FIG. 3B illustrates a flowchart of a process 300 for generating and rendering enriched content for a graphic story book according to various embodiments of the disclosure. The process 300 begins at step 305, where the conversion system obtains data associated with a graphic story book comprising a sequence of image panels. In some embodiments, this data may be uploaded by a user through the user interface application 112 on the user device 110, and may include visual content such as the sequence of image panels 322 that depict various scenes, characters, backgrounds, and text elements.

The process 300 continues to step 310, where an AI model extracts attributes associated with the graphic story book based on the obtained data. In some aspects, this step may involve the encoder module 302 performing feature extraction operations to analyze and understand the content within each image panel. The encoder module 302 may extract text features 324 representing textual content such as words within chat bubbles, narrative text, and sound effects, as well as image features 326 representing visual characteristics including background scenes, character appearances, facial features, body features, objects, colors, and spatial relationships between different elements within each panel.

At step 315, the AI model 312 generates enriched content for the graphic story book based on the extracted attributes. In some embodiments, this step may involve the AI model 312 analyzing the received features to understand narrative structure, character relationships, dialogue patterns, scene descriptions, and temporal sequences within the graphic story book. The AI model 312 may generate various types of processed data, including narrative descriptions for each image panel, voice profiles for different characters based on their visual characteristics, audio data representing spoken words and vocalizations, and video clips created by combining and processing multiple image panels that depict motion or action.

The conversion module 132 may package the generated audio data and video data (generated by the AI model 312) together with the original sequence of image panels 322 to form the enriched content 334 for the graphic story book. In some embodiments, the packaging process may involve creating data structures that link specific audio elements to corresponding image panels, establishing temporal relationships between different content components, and organizing the various media elements into a cohesive presentation format. The conversion module 132 may generate metadata that specifies timing information for when each audio narration should be played, which voice profile corresponds to each character's dialogue, and how video clips should be integrated with static image panels during playback.

The enriched content 334 may be structured as a multimedia package that contains the original visual elements enhanced with the generated audio and video components. In some aspects, this package may include synchronization data that coordinates the presentation of different media types, ensuring that audio narrations align with the display of corresponding image panels and that video clips seamlessly replace static sequences when appropriate. The package may also contain user preference settings that allow for customization of playback speed, voice characteristics, and presentation modes based on individual user profiles.

Once the enriched content 334 is fully assembled, the conversion module 132 may store the packaged content within the database 136 of the service provider server 130. In some embodiments, the database 136 may organize the enriched content using indexing systems that allow for efficient retrieval based on graphic story book titles, user preferences, or content characteristics. The stored enriched content 334 may be maintained in formats that are compatible with various user devices and applications, enabling seamless delivery and rendering across different platforms and device types.

The process 300 then moves to step 320, where a request to view the graphic story book is received from an application of a user device. In some cases, this request may be received by the conversion module 132 from the user interface application 112 when a user seeks to access the enriched content associated with a particular graphic story book. When a user requests access to a particular graphic story book through the user interface application 112, the conversion module 132 may retrieve the corresponding enriched content 334 from the database 136 and prepare it for transmission to the requesting user device 110.

At step 325, the process 300 accesses profile data associated with a user of the user device. In some embodiments, this profile data may include user preferences, reading speed, interaction history with other digitized graphic story books, or other personalization information that may be used to customize the presentation of the enriched content. In some cases, the conversion module 132 may customize the enriched content based on the user's profile data (which may also be stored in the database 136), adjusting presentation parameters such as playback speed, audio volume levels, or visual display preferences before delivering the content to the user device for rendering.

Finally, at step 330, the process 300 causes the user device to render the enriched content based on the profile data associated with the user. In some aspects, this step may involve the conversion module 132 communicating with the user interface application 112 to present the enriched content 334 via a user interface. The enriched content may include synchronized audio-visual presentations where specific audio elements are linked to corresponding image panels, video clips that replace static image sequences, and timeline information that controls the presentation sequence and timing of different content elements when rendered on the user device.

FIG. 4 illustrates an example artificial neural network 400 that may be used to implement the AI model (e.g., the AI model 312) used by the conversion module 132. As shown, the artificial neural network 400 includes three layers—an input layer 402, a hidden layer 404, and an output layer 406. Each of the layers 402, 404, and 406 may include one or more nodes. For example, the input layer 402 includes nodes 408-414, the hidden layer 404 includes nodes 416-420, and the output layer 406 includes a node 422. In this example, each node in a layer is connected to every node in an adjacent layer. For example, the node 408 in the input layer 402 is connected to all of the nodes 416-420 in the hidden layer 404. Similarly, the node 416 in the hidden layer is connected to all of the nodes 408-414 in the input layer 402 and the node 422 in the output layer 406. Although only one hidden layer is shown for the artificial neural network 400, it has been contemplated that the artificial neural network 400 used to implement any one of the computer-based models 252, 254, and 256 may include as many hidden layers as necessary.

In this example, the artificial neural network 400 receives a set of input values and produces an output value. Each node in the input layer 402 may correspond to a distinct input value. For example, when the artificial neural network 400 is used to implement the AI model 312, each node in the input layer 402 may correspond to a distinct feature (e.g., a distinct text feature, a distinct image feature) extracted from the sequence of image panels 322.

In some embodiments, each of the nodes 416-420 in the hidden layer 404 generates a representation, which may include a mathematical computation (or algorithm) that produces a value based on the input values received from the nodes 408-414. The mathematical computation may include assigning different weights (e.g., node weights, etc.) to each of the data values received from the nodes 408-414. The nodes 416-420 may include different algorithms and/or different weights assigned to the data variables from the nodes 408-414 such that each of the nodes 416-420 may produce a different value based on the same input values received from the nodes 408-414. In some embodiments, the weights that are initially assigned to the features (or input values) for each of the nodes 416-420 may be randomly generated (e.g., using a computer randomizer). The values generated by the nodes 416-420 may be used by the node 422 in the output layer 406 to produce an output value for the artificial neural network 400. When the artificial neural network 400 is used to implement the AI model 312, the output values produced by the artificial neural network 400 may represent enriched data generated by the AI model 312 based on the sequence of image panels 322, such as audio data representing the narration of the image panels, voices of spoken words corresponding to different characters of the graphic story book, etc., video data such as the short video clips generated by the AI model 312 by stitching multiple image panels together, etc.

The artificial neural network 400 may be trained by using training data. By providing training data to the artificial neural network 400, the nodes 416-420 in the hidden layer 404 may be trained (adjusted) such that an optimal output (e.g., a classification) is produced in the output layer 406 based on the training data. By continuously providing different sets of training data, and penalizing the artificial neural network 400 when the output of the artificial neural network 400 is incorrect (e.g., when the determined (predicted) likelihood is inconsistent with whether the profile is connected with the entity, etc.), the artificial neural network 400 (and specifically, the representations of the nodes in the hidden layer 404) may be trained (adjusted) to improve its performance in data classification. Adjusting the artificial neural network 400 may include adjusting the weights associated with each node in the hidden layer 404.

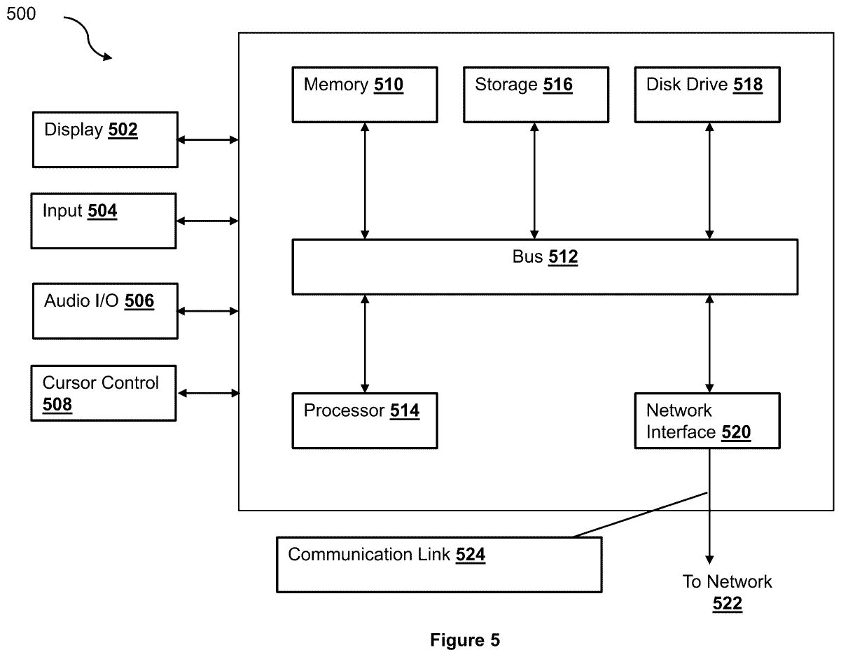

FIG. 5 is a block diagram of a computer system 500 suitable for implementing one or more embodiments of the present disclosure, including the service provider server 130 and the user device 110. In various implementations, the user device 110 may include a mobile cellular phone, personal computer (PC), laptop, wearable computing device, etc. adapted for wireless communication, and the service provider server 130 may include a network computing device, such as a server. Thus, it should be appreciated that the devices 110 and 130 may be implemented as the computer system 500 in a manner as follows.

The computer system 500 includes a bus 512 or other communication mechanism for communicating information data, signals, and information between various components of the computer system 500. The components include an input/output (I/O) component 504 that processes a user (i.e., sender, recipient, service provider) action, such as selecting keys from a keypad/keyboard, selecting one or more buttons or links, etc., and sends a corresponding signal to the bus 512. The I/O component 504 may also include an output component, such as a display 502 and a cursor control 508 (such as a keyboard, keypad, mouse, etc.). The display 502 may be configured to present a login page for logging into a user account or a checkout page for purchasing an item from a merchant. An optional audio input/output component 506 may also be included to allow a user to use voice for inputting information by converting audio signals. The audio I/O component 506 may allow the user to hear audio. A transceiver or network interface 520 transmits and receives signals between the computer system 500 and other devices, such as another user device, a merchant server, or a service provider server via network 522. In one embodiment, the transmission is wireless, although other transmission mediums and methods may also be suitable. A processor 514, which can be a micro-controller, digital signal processor (DSP), or other processing component, processes these various signals, such as for display on the computer system 500 or transmission to other devices via a communication link 524. The processor 514 may also control transmission of information, such as cookies or IP addresses, to other devices.

The components of the computer system 500 also include a system memory component 510 (e.g., RAM), a static storage component 516 (e.g., ROM), and/or a disk drive 518 (e.g., a solid-state drive, a hard drive). The computer system 500 performs specific operations by the processor 514 and other components by executing one or more sequences of instructions contained in the system memory component 510.

Logic may be encoded in a computer readable medium, which may refer to any medium that participates in providing instructions to the processor 514 for execution. Such a medium may take many forms, including but not limited to, non-volatile media, volatile media, and transmission media. In various implementations, non-volatile media includes optical or magnetic disks, volatile media includes dynamic memory, such as the system memory component 510, and transmission media includes coaxial cables, copper wire, and fiber optics, including wires that comprise the bus 512. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 500. In various other embodiments of the present disclosure, a plurality of computer systems 500 coupled by the communication link 524 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors communicatively coupled to the non-transitory memory and configured to read instructions from the non-transitory memory to cause the system to perform operations comprising:
receiving content associated with a graphic story book comprising a sequence of image panels;
extracting features from the sequence of image panels, wherein the features comprise (i) image features representing one or more objects within each image panel in the sequence of image panels and (ii) text features representing text content within the sequence of image panels;
enriching, using an artificial intelligence (AI) model, the content based on the extracted features from the sequence of image panels, wherein the enriched content comprises audio content corresponding to at least one of a verbal description of a scene represented by one or more of the sequence of image panels or utterances from one or more characters in the one or more of the sequence of the image panels; and
causing an application of a mobile device to present the enriched content.

2. The system of claim 1, wherein the features extracted from the sequence of image panels further comprise character features representing visual attributes of one or more characters that appear in the sequence of image panels.

3. The system of claim 2, wherein the character features comprise facial features and body features.

4. The system of claim 1, wherein the enriched content comprises a time dimension, and wherein different portions of the enriched content are presented by the application according to a timeline.

5. The system of claim 1, wherein the operations further comprise:
analyzing facial features and body features associated with a character that appears in an image panel in the sequence of image panels, wherein the image panel comprises text representing words spoken by the character;
selecting, using the AI model, a voice profile for the character based on the facial features and the body features; and
generating, for the image panel, an audio clip representing the character speaking the words based on the voice profile.

6. The system of claim 5, wherein the operations further comprise:
obtaining a plurality of voice contents associated with a plurality of people;
determining physical attributes associated with the plurality of people;
assigning each of the plurality of voice contents to one of a plurality of clusters based on one or more physical attributes associated with the corresponding person; and
matching the facial features and the body features associated with the character with a particular cluster from the plurality of clusters, wherein the voice profile is selected for the character further based on the particular cluster.

7. The system of claim 1, wherein the enriching the content comprises:
selecting, from the plurality of image panels, two or more image panels that represent a sequence of related movements performed by one or more characters; and
generating a video clip for presenting the sequence of related movements based on the two or more image panels.

8. The system of claim 7, wherein the generating the video clip comprises:
using the two or more image panels as a plurality of video frames for the video clip; and
generating one or more additional video frames for the video clip based on the two or more image panels.

9. The system of claim 8, wherein the generating the video clip further comprises:
inserting at least one of the one or more additional video frames in between two video frames from the plurality of video frames.

10. The system of claim 1, wherein causing the application to present the enriched content comprises causing the application not present different portions of the enriched content at specific time frames within a time period.

11. A method comprising:
receiving, by a computer system, content associated with a graphic story book comprising a sequence of image panels;
extracting, by the computer system, features from the sequence of image panels, wherein the features comprise (i) image features representing one or more objects within each image panel in the sequence of image panels and (ii) text features representing text content within the sequence of image panels;
enriching, by the computer system and using an artificial intelligence (AI) model, the content based on the extracted features from the sequence of image panels, wherein the enriched content comprises audio content corresponding to at least one of a verbal description of a scene represented by one or more of the sequence of image panels or utterances from one or more characters in the one or more of the sequence of the image panels; and
causing, by the computer system, an application of a mobile device to present the enriched content.

12. The method of claim 11, wherein the features extracted from the sequence of image panels further comprise character features representing visual attributes of one or more characters that appear in the sequence of image panels.

13. The method of claim 12, wherein the character features comprise facial features and body features.

14. The method of claim 11, wherein the enriched content comprises a time dimension, and wherein different portions of the enriched content are presented by the application according to a timeline.

15. The method of claim 11, further comprising:
analyzing, by the one or more hardware processors, facial features and body features associated with a character that appears in an image panel in the sequence of image panels, wherein the image panel comprises text representing words spoken by the character;
selecting, by the one or more hardware processors using the AI model, a voice profile for the character based on the facial features and the body features; and
generating, by the one or more hardware processors for the image panel, an audio clip representing the character speaking the words based on the voice profile.

16. The method of claim 15, further comprising:
obtaining, by the one or more hardware processors, a plurality of voice contents associated with a plurality of people;
determining, by the one or more hardware processors, physical attributes associated with the plurality of people;
assigning, by the one or more hardware processors, each of the plurality of voice contents to one of a plurality of clusters based on one or more physical attributes associated with the corresponding person; and
matching, by the one or more hardware processors, the facial features and the body features associated with the character with a particular cluster from the plurality of clusters, wherein the voice profile is selected for the character further based on the particular cluster.

17. The method of claim 11, wherein the enriching the content comprises:
selecting, by the one or more hardware processors from the plurality of image panels, two or more image panels that represent a sequence of related movements performed by one or more characters; and
generating, by the one or more hardware processors, a video clip for presenting the sequence of related movements based on the two or more image panels.

18. The method of claim 17, wherein the generating the video clip comprises:
using, by the one or more hardware processors, the two or more image panels as a plurality of video frames for the video clip; and
generating, by the one or more hardware processors, one or more additional video frames for the video clip based on the two or more image panels.

19. The method of claim 18, wherein the generating the video clip further comprises:
inserting, by the one or more hardware processors, at least one of the one or more additional video frames in between two video frames from the plurality of video frames.

20. The method of claim 11, wherein causing the application to present the enriched content comprises causing the application not present different portions of the enriched content at specific time frames within a time period.
